(19) United States
(12) Patent Application Publication
(10) Pub. No.: US 2026/0145446 A1
(43) Pub. Date: May 28, 2026

(54) DUPLEX PRINTING SYSTEM FOR A CARD PERSONALIZATION SYSTEM

(71) Applicant: Entrust Corporation, Shakopee, MN (US)

(72) Inventors: Cory WOOLDRIDGE, Shakopee, MN (US); Tim FLITSCH, Shakopee, MN (US); Jon WAWRA, Shakopee, MN (US)

(21) Appl. No.: 19/393,873

(22) Filed: Nov. 19, 2025

Related U.S. Application Data
(60) Provisional application No. 63/723,906, filed on Nov. 22, 2024.

(51) Int. Cl. B41J 13/12; B41J 3/407; B41J 3/60; B41J 11/00; B42D 15/02

(52) U.S. Cl. CPC B41J 13/12; B41J 3/407; B41J 3/60; B41J 11/0021; B42D 15/02

(57) ABSTRACT

A duplex printing system for performing duplex printing on cards, and a card personalization system that includes the duplex printing system. In each instance, the duplex printing system is configured to have at least two cards simultaneously therein whereby the two cards are simultaneously processed by the duplex printing system. The duplex printing system further includes a card printing mechanism that is configured to perform printing on the two cards, and a card flipper that is configured to flip the cards. First and second separately movable card transports support the two cards thereon so that each of the two cards can be separately transported through the duplex printing system including to and from the card printing mechanism and the card flipper.

### PRIORITY

This application claims priority to U.S. provisional application Ser. No. 63/723,906, filed on Nov. 22, 2024, the entire contents of which are incorporated herein by reference.

### FIELD

This disclosure relates to card personalization systems that personalize cards including, but not limited to, financial (e.g., credit, debit, or the like) cards, driver's licenses, national identification cards, business identification cards, gift cards, and other cards, and to transporting cards in such card personalization systems.

### BACKGROUND

Cards such as financial cards including credit and debit cards, identification cards, driver's licenses, and other similar cards may be personalized with personal information of the intended cardholder. Examples of personalization include, but not are limited to, names, addresses, photographs, account numbers, employee numbers, or the like. The personal information may be applied to the card in a number of different ways including printing on a surface of the card. In some instances, both surfaces of the card may need to be printed on, which is referred to as duplex printing.

### SUMMARY

A duplex printing system for performing duplex printing on cards, and a card personalization system that includes the duplex printing system, are described herein. The duplex printing system is configured to have at least two cards simultaneously therein whereby the two cards are simultaneously processed by the duplex printing system. The duplex printing system further includes a card printing mechanism that is configured to perform printing on the two cards, and a card flipper that is configured to flip the cards. First and second separately movable card transports support the two cards thereon so that each of the two cards can be separately transported through the duplex printing system.

In an embodiment, the card printing mechanism and the card flipper are located between a common card pick-up position and a common card discharge position. Each of the card transport are separately actuatable to occupy the common card pick-up position to pick-up their respective card and occupy the common card discharge position to discharge their respective card after printing on the respective card by the card printing mechanism is complete. The first and second separately movable card transports are each separately actuatable to transport their respective cards within the duplex printing system including to and from the card printing mechanism and the card flipper.

Because the first and second card transports are separately actuatable, a number of printing sequences on the two cards are possible. For example, the duplex printing system can be controlled to implement the following printing sequence: printing on one side of the first card, followed by printing on one side of the second card, followed by printing on the opposite side of the first card, followed by printing on the opposite side of the second card.

In another possible printing sequence, assuming that each card has an A side and a B side, the duplex printing system can be controlled to implement the following printing sequence: printing on the A side of the first card, followed by printing on the A side of the second card, followed by printing on the B side of the first card, followed by printing on the B side of the second card. This printing sequence may be referred to as an AABB printing sequence. Other printing sequences are possible including printing on the A side of the first card, followed by printing on the B side of the first card, followed by printing on the A side of the second card, followed by printing on the B side of the second card (an ABAB printing sequence); or printing on the A side of the first card, followed by printing on the B side of the second card, followed by printing on the B side of the first card, followed by printing on the A side of the second card (an ABBA printing sequence); or printing on the A side of the first card, followed by printing on the B side of the second card, followed by printing on the A side of the second card, followed by printing on the B side of the first card (also an ABAB printing sequence); or printing on the B side of the first card, followed by printing on the B side of the second card, followed by printing on the A side of the first card, followed by printing on the A side of the second card (a BBAA printing sequence); and many other printing sequences.

The A side of the first card and the A side of the second card are the same sides of the two cards, such as the sides intended to have the printed images of the intended cardholders of the two cards, or the sides intended to have the account numbers, or the sides intended to have the names of the intended cardholders of the two cards. Similarly, the B side of the first card and the B side of the second card are the same sides of the two cards, such as the sides having magnetic strips, or the sides intended to have CVV codes, or the sides intended to have expiration dates of the cards, or the sides having signature panels for receiving signatures of the intended cardholders of the two cards. There are other ways that the A and B sides of the cards could be characterized. However one characterizes the A and B sides, the A side of the first card is intended to be the same side as the A side of the second card, and the B side of the first card is intended to be the same side as the B side of the second card.

In an embodiment, the two cards can initially enter the card printing mechanism with the A sides thereof facing upward for printing on the A sides and the B sides thereof facing downward. The cards may then be flipped in the duplex printing mechanism so that the B sides thereof now face upward for printing on the B sides and the A sides thereof now face downward. In another embodiment, the two cards can initially enter the card printing mechanism with different surfaces facing upward so that different surfaces are initially printed.

The card printing mechanism can be configured to perform any type of printing suitable for personalizing cards. For example, the card printing mechanism can be configured for monochromatic or multi-color drop-on-demand (DOD) printing, or configured for monochromatic or multi-color thermal printing using one or more thermal printheads and one or more print ribbons. During printing, the cards may be oriented in a substantially horizontal plane with the surfaces thereof facing upward and downward, or the cards may be oriented in a substantially vertical plane with the surfaces thereof facing sideways.

A duplex printing system that is usable in a card personalization system can include a common card pick-up position; a common card discharge position; a card printing mechanism between the common card pick-up position and the common card discharge position, where the card printing mechanism is configured to perform printing on cards that are input into the duplex printing system; a card flipper between the common card pick-up position and the common card discharge position, where the card flipper is configured to flip a card; and a card transport mechanism that transports cards within the duplex printing system including to and from the card printing mechanism and the card flipper, where the card transport mechanism includes first and second separately movable card transports each of which is configured to support a respective card thereon. The first and second separately movable card transports are each separately actuatable to occupy the common card pick-up position and occupy the common card discharge position, and the first and second separately movable card transports are each separately actuatable to move between the common card pick-up position and the common card discharge position and transport the cards to and from the card printing mechanism and the card flipper.

In another example, a duplex printing system that is usable in a card personalization system can include a card infeed; a card discharge; a card printing mechanism between the card infeed and the card discharge, where the card printing mechanism is configured to perform printing on cards that are input into the duplex printing system; a card flipper between the card infeed and the card discharge, where the card flipper is configured to flip a card; a card transport mechanism that transports cards within the duplex printing system, where the card transport mechanism includes first and second separately movable card transports each of which is configured to support a respective card thereon; and a system controller that is configured to control the duplex printing system to simultaneously have a first card and a second card therein, with the first card on the first movable card transport and the second card on the second movable card transport. Each of the first card and the second card has an A side and a B side, and the system controller controls the duplex printing system to implement the following printing sequence: printing on the A side of the first card, followed by printing on the A side of the second card, followed by printing on the B side of the first card, followed by printing on the B side of the second card.

In an embodiment, the card printing system can be controlled to switch from a duplex printing mode where both sides of the cards are printed on, to a simplex printing mode for printing on only a single side of the cards for cards that require only single-sided printing. The card printing system may be switched back and forth between the duplex printing mode and the simplex printing mode by a system controller depending upon whether the cards require two-sided printing or single sided printing. When operating in the duplex printing mode, the card printing system may be referred to as a duplex card printing system; when operating in the simplex printing mode, the card printing system may be referred to as a simplex card printing system; or the language card printing system may refer to the system operating in either the duplex printing mode or the simplex printing mode. In the described card printing system, because the card transport mechanism is configured so that the cards do not need to be transferred from one of the movable card transports to the other, the described card printing system can operate faster in the simplex printing mode compared to a card printing system that needs to transfer cards from one card transport mechanism in the card printing system to a second card transport mechanism in the card printing system.

In another example, a duplex printing system that is usable in a card personalization system can include a card infeed; a card discharge; a card printing mechanism between the card infeed and the card discharge, where the card printing mechanism is configured to perform printing on cards that are input into the duplex printing system; a card flipper between the card infeed and the card discharge, where the card flipper is configured to flip a card; a card transport mechanism that transports cards within the duplex printing system, where the card transport mechanism includes first and second separately movable card transports each of which is configured to support a respective card thereon; and a system controller that is configured to control the duplex printing system to simultaneously have a first card and a second card therein, with the first card on the first movable card transport and the second card on the second movable card transport. The system controller controls the duplex printing system to implement the following printing sequence: printing on one side of the first card, followed by printing on one side of the second card, followed by printing on an opposite side of the first card, followed by printing on an opposite side of the second card.

In an embodiment, one or both of the cards can be returned back to the card printing mechanism by its associated card transport, without flipping the card, for additional printing on the same side of the card.

### DRAWINGS

FIG. 1 is a schematic depiction of a duplex printing system described herein.

FIG. 2 illustrates an example of a side or surface of a card.

FIG. 3 is a perspective view of one embodiment of a card transport mechanism of the duplex printing system described herein.

FIG. 4 is an end view of the card transport mechanism of FIG. 3.

FIG. 5 is a schematic top view depicting the card transport mechanism of FIGS. 3 and 4.

FIG. 6 is a schematic top view depicting the card transport mechanism of FIGS. 3 and 4 in another embodiment of a duplex printing system.

FIG. 7 depicts an example of a printing sequence that can be implemented by the duplex printing systems described herein.

FIG. 8 depicts another example of a printing sequence that can be implemented by the duplex printing system of FIG. 6.

FIG. 9 depicts an example of a card personalization with the duplex printing system described herein.

FIG. 10 depicts another example of a card personalization with the duplex printing system described herein.

### DETAILED DESCRIPTION

The following is a description of duplex printing systems for performing duplex printing on cards, and a card personalization system that includes the duplex printing system. In each instance, the duplex printing system is configured to have at least two cards simultaneously therein whereby the two cards are simultaneously processed by the duplex printing system. The duplex printing system further includes a card printing mechanism that is configured to perform printing on the two cards, and a card flipper that is configured to flip the cards. First and second separately movable card transports support the two cards thereon so that each of the two cards can be separately transported through the duplex printing system including to and from the card printing mechanism and the card flipper.

The cards described herein may be any type of cards that are personalized with personal information of the intended cardholder and subsequently issued to the card holder. Examples of cards include financial (e.g., credit, debit, or the like) cards, driver's licenses, national identification cards, business identification cards, and other cards which bear or will bear personalized data unique and/or assigned to the cardholder. A financial card, which may also be referred to as a credit card or a debit card, as used herein refers to a type of card that allows the cardholder to borrow funds or that has a stored monetary value. A financial card typically has at least a cardholder name and an account number provided thereon, often by printing. A financial card may also have an integrated circuit chip that stores data relating to the card and/or a magnetic strip that stores data relating to the card and/or a signature panel that allows a user to sign their name and/or a holographic foil patch. The term “personalized card” is often used in the personalized card industry to refer to a card that already bears personalization and to which additional personalization will be printed, or that does not bear any personalization and to which personalization will be initially applied.

The cards can be made entirely of plastic, or a combination of plastic and non-plastic materials. In an embodiment, the card may be made entirely of non-plastic materials such as paper or metal. In an embodiment, the card may be made of a plastic such as polycarbonate, polyvinyl chloride (PVC), polyethylene terephthalate glycol (PETG), and other plastics. In an embodiment, the cards may be ID-1 cards as defined by ISO/IEC 7810. However, other card formats such as ID-2 as defined by ISO/IEC 7810 are possible as well.

The term “personalization” (or the like) as used throughout the specification and claims, unless indicated otherwise, is intended to encompass operations performed on a card that includes operations that result in personalizing the card as well as operations that do not result in personalizing the card. An example of a personalization operation that personalizes the card is printing the intended cardholder's image or name on the card. An example of a personalization operation that does not personalize the card is printing non-cardholder graphics on the card. The term “personalize” is often used in the personalized card industry to refer to a card that undergoes both personalization processing operations and non-personalization processing operations.

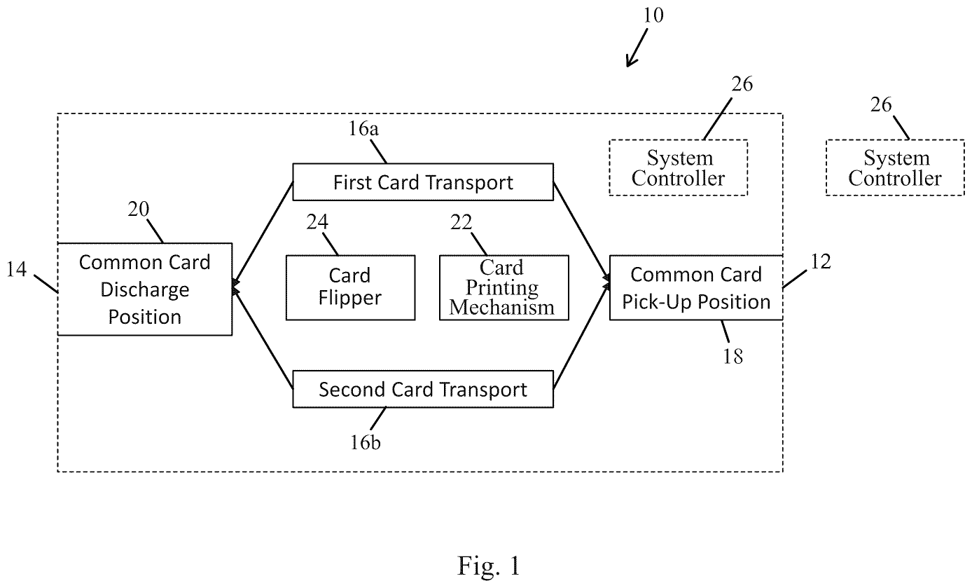

FIG. 1 illustrates an example of a duplex printing system 10 described herein. The system 10 may also be referred to using other nomenclature including, but not limited to, a duplex card printing system, a duplex printing module, a duplex card printing module, a duplex printing mechanism, a duplex printing station, a duplex card printing mechanism, or a duplex card printing station. The duplex printing system 10 includes a card input 12 (or a card infeed) at one end thereof through which a card can enter the system 10, and a card output 14 (or a card discharge) at the opposite end through which a card can exit the system 10. The card input 12 and the card output 14 can take any form suitable for allowing cards to enter and exit the system 10, for example input and output slots.

The system 10 further includes a card transport mechanism that transports cards within the system 10. The card transport mechanism may be similar to the card transport mechanism described in U.S. Pat. No. 10,507,677 or in U.S. Patent Publication No. 2020/0070550, the entire contents of each are incorporated herein by reference.

Referring to FIG. 1, the card transport mechanism has at least first and second separate card transports 16a, 16b each of which can receive a card from the card input 12, support the card as the card is transported in the system 10, and ultimately deliver the card to the card output 14. Although the card transport mechanism is illustrated as having the two card transports 16a, 16b, additional card transports can be provided as well.

Still referring to FIG. 1, a common card pick-up position 18 is defined near or adjacent to the card input 12, while a common card discharge position 20 is defined near or adjacent to the card output 14. The common card pick-up position 18 and the common card discharge position 20 are locations in the system 10 that permit each of the card transports 16a, 16b to be separately positioned at separate times at the same location in the system to pick-up cards that are input via the card input 12 and to deliver the cards to the card output 14 for discharge of the cards. So the word common in “common card pick-up position 18” and in “common card discharge position 20” refers to the situation where the card transports 16a, 16b can each occupy the same space in the system 10, but at different times, and the card transport mechanism is suitably designed to actuate the card transports 16a, 16b between the common card pick-up position 18 and the common card discharge position 20 without the card transports 16a, 16b interfering with one another.

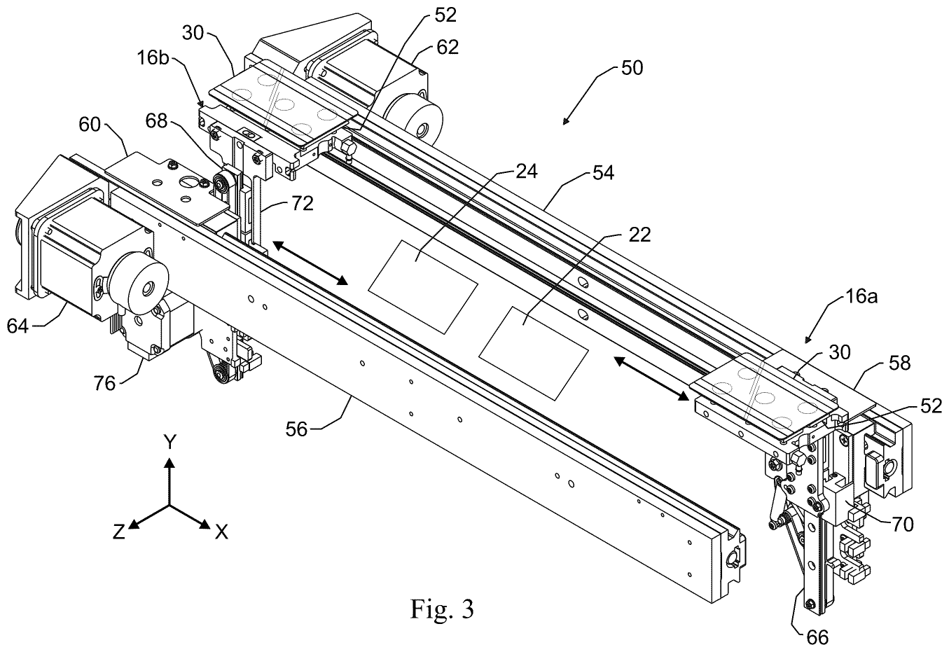

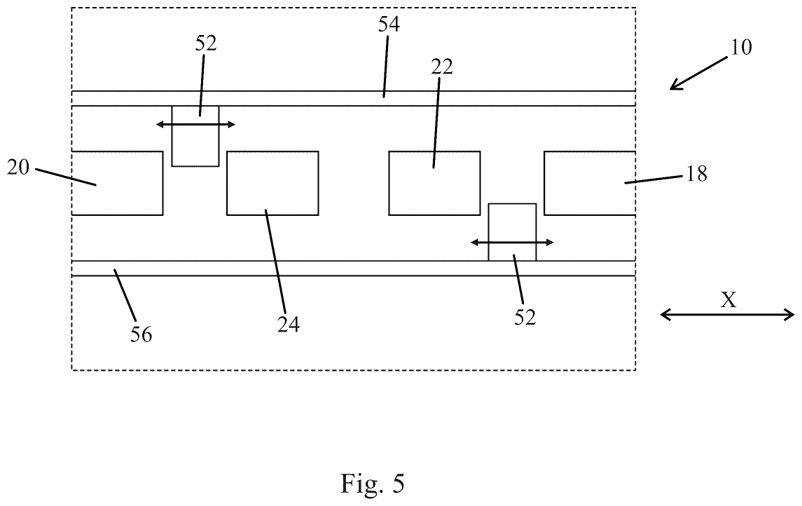

Each of the card transports 16a, 16b are separately actuatable to separately occupy the common card pick-up position 18 to pick up cards that are input via the card input 12, as well as being separately actuatable to separately occupy the common card discharge position 20 to deliver cards to the card output 14. In addition to being actuatable to the common card pick-up position 18 and to the common card discharge position 20, the first and second card transports 16a, 16b are each separately actuatable to move back and forth between the common card pick-up position 18 and the common card discharge position 20. The card transports 16a, 16b can have any configuration suitable for picking up, transporting and discharging cards in this manner. A non-limiting example of the card transports 16a, 16b is described below with respect to FIGS. 3-5.

Still referring to FIG. 1, a card printing mechanism 22 and a card flipper 24 are located between the common card pick-up position 18 and the common card discharge position 20 along the path of travel of the card transports 16a, 16b. Each card may be transported by its respective card transport 16a, 16b from the common card pick-up position 18 to anywhere in the system 10, including to and between the card printing mechanism 22 and the card flipper 24, and ultimately to the common card discharge position 20.

The card printing mechanism 22 is configured to perform printing on cards that are input into the duplex printing system 10. In an embodiment, the card printing mechanism 22 can be configured to perform DOD printing using ink. The DOD printing may be monochromatic (for example black or a specialty color) from a single DOD printhead, or multi-color (for CMYK) from multiple DOD printheads one for each color. The ink used in the DOD printing may be radiation curable ink, such as ultraviolet (UV) curable ink. The DOD printing may also apply material other than ink such as a varnish that is applied over previously applied ink. The varnish may be radiation curable, and may be transparent or semi-transparent. In another embodiment, the card printing mechanism 22 can be configured to perform direct-to-card thermal transfer printing from one or more thermal printheads and one or more thermal print ribbons. The thermal transfer printing may be monochromatic (for example black or a specialty color) or multi-color (CMYK). An example of a DOD printing mechanism that prints radiation curable material in a card personalization system is described in U.S. Pat. No. 10,049,320 which is incorporated herein by reference in its entirety. An example of a thermal transfer printing mechanism that performs thermal transfer printing of a radiation curable material from a print ribbon using a thermal print head is described in U.S. Pat. No. 10,889,129 which is incorporated herein by reference in its entirety.

The card flipper 24 is configured to flip a card 180 degrees. For example, after printing on one side of the card, the card is introduced into the card flipper 24 which flips the card 180 degrees to position the opposite side for printing on the opposite side. An example of a card flipper is described in U.S. Pat. No. 10,384,883 which is incorporated herein by reference in its entirety.

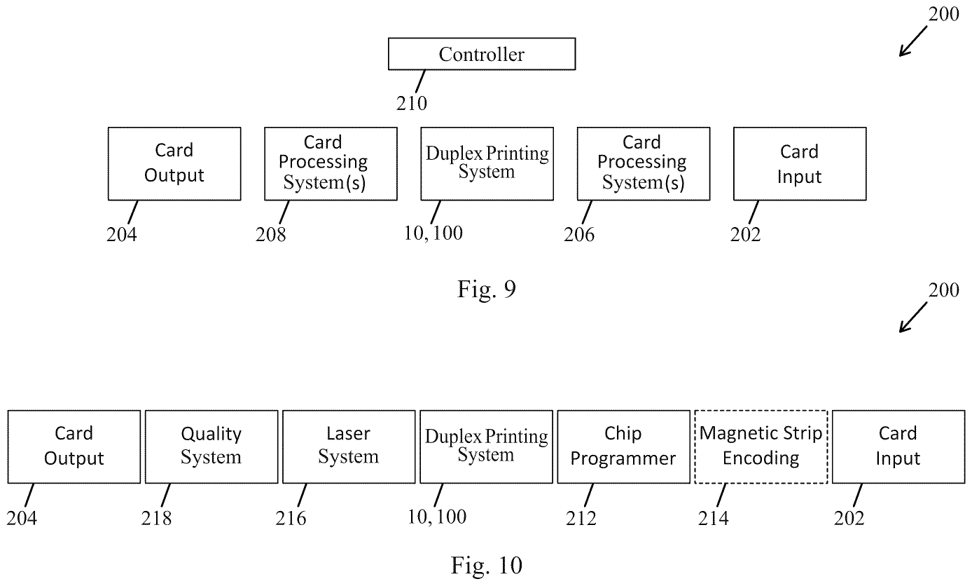

Operation of the duplex printing system 10, including operation of the card transports 16a, 16b, the card printing mechanism 22 and the card flipper 24, is controlled by a system controller 26. As depicted in FIG. 1, the system controller 26 may be external to the duplex printing system 10. For example, if the system 10 is incorporated into a larger card personalization system (as described below with respect to FIGS. 9 and 10), the system controller 26 may be the controller used to control the larger card personalization system. Alternatively, the system controller 26 may be internal to the duplex printing system 10 (as depicted in dashed lines in FIG. 1), and possibly dedicated to controlling just the system 10.

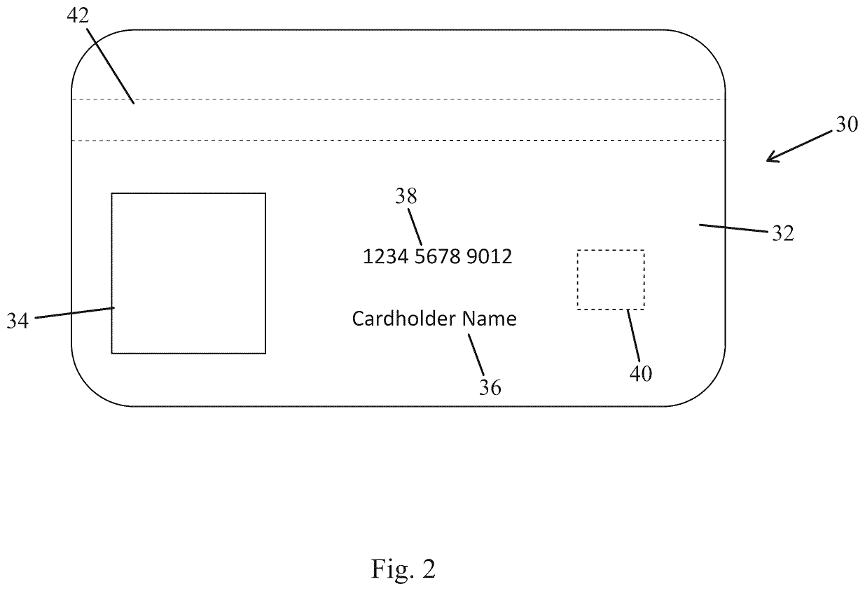

An example of a card 30 that can be personalized in the system 10 is illustrated in FIG. 2. The card 30 may be an identification card, a driver's license, a financial card including a credit and debit card, and other personalized cards. The card 30 is depicted as including a side 32 (or surface 32); the opposite side (or surface) is not visible in FIG. 2. The side 32 may be referred to as an A side with the opposite side referred to as a B side. Alternatively, the side 32 may be referred to as the B side with the opposite side referred to as the A side. The side 32 may also be referred to as a front surface of the card 30, with the opposite side referred to as a back side or rear side of the card 30. FIG. 2 depicts printing applied to the side 32. The printing can include a printed image (i.e. a portrait image) 34 of the intended holder of the card 30, where the printed image 34 can be a monochromatic image or a multicolor image for example printed from CMYK inks; a cardholder name 36, address and other personal data of the intended cardholder; and/or a document number such as an account number 38. Printing applied to the opposite or B side of the card 30 can include personal data such as the cardholder name, address and other personal data of the intended cardholder; the document number such as the account number; an expiration date; a CVV number; a telephone number or website address to contact the card issuer; and other information. The card 30 may also include an integrated circuit chip 40 that can be electronically programmed with data. The card 30 may also include a magnetic strip 42 (often disposed on the B side that is opposite the side 32) that can be magnetically encoded with data.

Referring to FIGS. 3-5, an embodiment of a card transport mechanism 50 for transporting cards within the system 10 is illustrated. In this embodiment, the first card transport 16a and the second card transport 16b are each in the form of a vacuum platen 52. For sake of convenience, cards 30 are shown (in transparent) on the vacuum platens 52 of the first and second card transport 16a, 16b. Each vacuum platen 52 is configured to apply a vacuum to a card disposed thereon, much like a conventional vacuum belt, to retain the card in position on the platen 52 during transport and during printing in the card printing mechanism 22. The vacuum platens 52 can have any configuration suitable for applying a vacuum to the cards to retain the cards on the platens. For example, each of the vacuum platens 52 can have a plurality of holes therein, such as four corner holes and one central hole. The holes are in communication with a vacuum source that applies a vacuum to the holes which act on the facing card surface to retain the cards on the platens 52. However, other configurations and patterns of holes can be used.

The card transport mechanism 50 includes a pair of parallel rails 54, 56 that extend longitudinally in the card transport direction parallel to the card processing path and to the return path from generally one end of the system 10 to the other end. The card transport mechanism 50 is a two axis or an X-Y axis transport system where each of the vacuum platens 52 is actuatable along the X and Y axes in FIG. 3. In particular, a longitudinal shuttle 58, 60 is slidably disposed on each rail 54, 56 for movement along the length of each rail 54, 56 in an X-axis direction actuated by drive motors 62, 64 that are in driving engagement with the longitudinal shuttles 58, 60 via suitable drive mechanisms. In addition, a vertical rail 66, 68 is mounted on each shuttle 58, 60 and a vertical shuttle 70, 72 is slidably disposed on each vertical rail 66 68 for movement along the length of each vertical rail 66, 68 in a Y-axis direction actuated by drive motors 74, 76 that are in driving engagement with the vertical shuttles 70, 72 via suitable drive mechanisms. The vacuum platens 52 are fixed to and move with the vertical shuttles 70, 72.

FIG. 3 illustrates the platens 52 of the card transports 16b, 16a at an elevated position at the common card pick-up position and at the common card discharge position, respectively. At these positions, the platens 52 are ready to pick-up a card and to discharge a printed card, respectively.

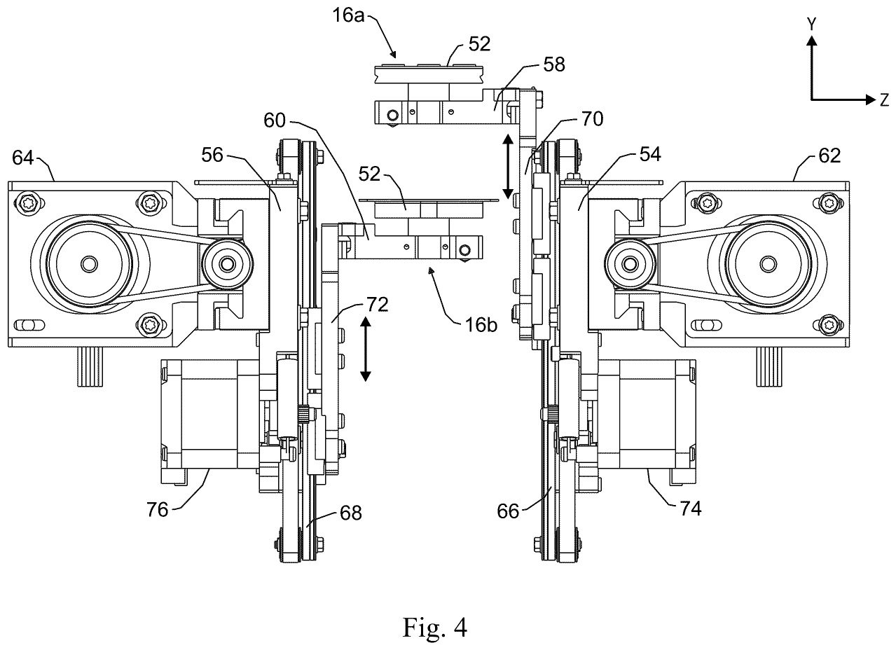

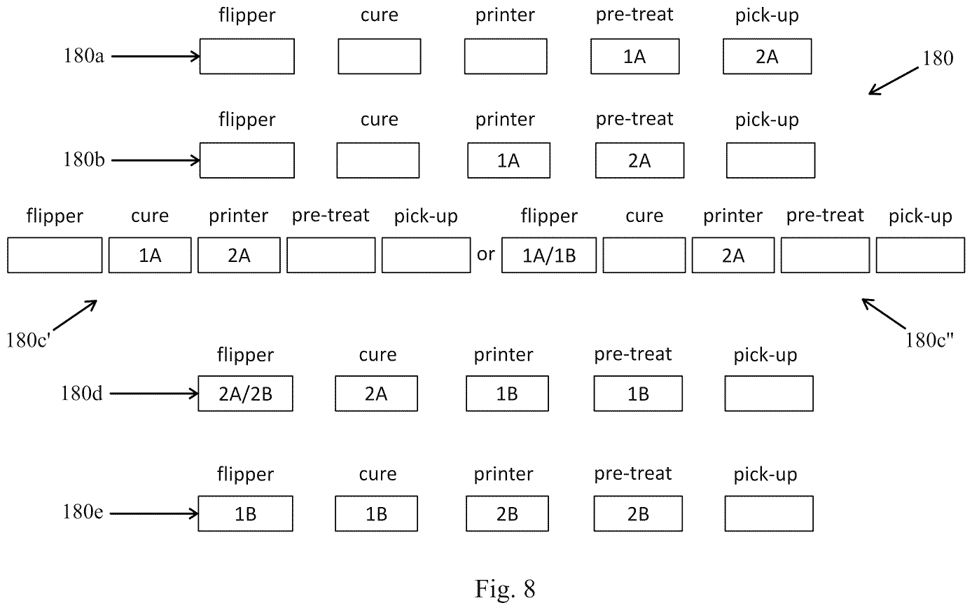

FIG. 4 shows the platen 52 of the card transport 16a still at the elevated position after having picked-up a card at the common card pick-up position. At the same time, the platen 52 of the card transport 16b has been vertically lowered. This allows the card transport 16b to pass underneath the card transport 16a. Similarly, at other times the platen 52 of the card transport 16b may be vertically raised while the platen 52 of the card transport 16a may be vertically lowered to allow the card transport 16a to pass underneath the card transport 16b. The vertical displacements of the card transports 16a, 16b permit the card transports to transport their respective cards within the system 10, including to and from the card printing mechanism 22, to and from the card flipper 24, and between the card flipper 24 and the card printing mechanism 22. Instead of vertical displacements to allow the card transports 16a, 16b to move past one another, the card transports 16a, 16b can be configured for Z-axis displacement as disclosed in FIG. 8 of U.S. Pat. No. 10,507,677 or configured to rotate out of position as disclosed in FIG. 9 of U.S. Pat. No. 10,507,677, the entire contents of which are incorporated herein by reference.

In general, referring to FIGS. 1 and 3-5, the printing sequence that is implemented by the duplex printing system 10 based on controlling movements of the card transports 16a, 16b can be as follows: printing on one side of the first card (for example the card held by the card transport 16a) in the card printing mechanism 22, followed by printing on one side of the second card (for example the card held by the card transport 16b) in the card printing mechanism 22, followed by printing on an opposite side of the first card (the card held by the card transport 16a after flipping the card in the card flipper 24) in the card printing mechanism 22, followed by printing on an opposite side of the second card (the card held by the card transport 16b after flipping the card in the card flipper 24) in the card printing mechanism 22. To permit flipping of the card, the vacuum of the platen 52 holding the particular card may be released allowing the flipper to remove the card from the platen 52, flip the card 180 degrees, and ultimately return the card back onto the platen where the vacuum is then reinstated to secure the card on the platen.

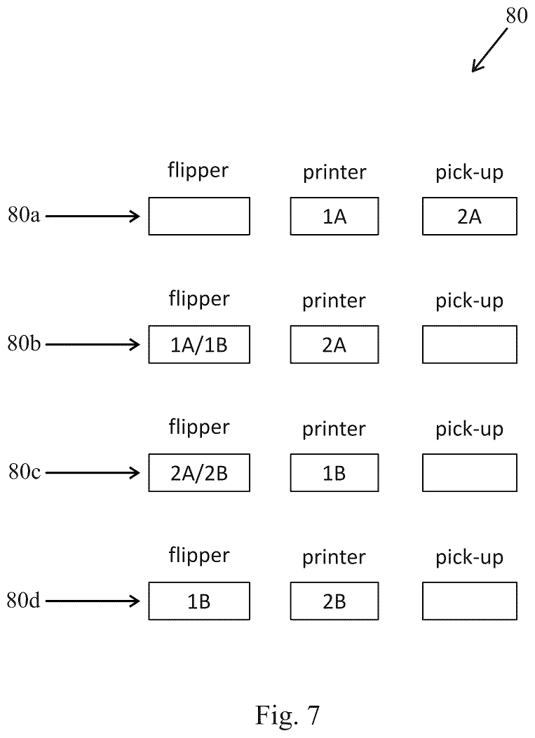

Referring to FIG. 7 along with FIGS. 1 and 3-5, another example of a printing sequence 80 that can be implemented by the duplex printing system 10 is illustrated. In this example printing sequence 80, the first card held on the card transport 16a is referenced using numeral “1” and the second card held on the card transport 16b is referenced using numeral “2”. In addition, each card is depicted as having an A side and a B side. As explained above, the A side of the first card and the A side of the second card are the same sides of the two cards, such as the sides intended to have the printed images of the intended cardholders of the two cards, or the sides intended to have the account numbers, or the sides intended to have the names of the intended cardholders of the two cards, etc. Similarly, the B side of the first card and the B side of the second card are the same sides of the two cards, such as the sides having the magnetic strips, or the sides intended to have the CVV codes, or the sides intended to have expiration dates of the cards, or the sides having signature panels for receiving signatures of the intended cardholders of the two cards, etc. There are other ways that the A and B sides of the cards could be characterized. However one characterizes the A and B sides, the A side of the first card is intended to be the same side as the A side of the second card, and the B side of the first card is intended to be the same side as the B side of the second card.

In the printing sequence 80 in FIG. 7, at 80a the card transport 16a has been actuated to the common card pick-up position 18 and has picked-up the first card with the A side thereof facing in a direction, such as upward, for printing, followed by the card transport 16a transporting the first card into the card printing mechanism for printing on the A side (this is indicated as 1A). Also, the card transport 16b is depicted at the common card pick-up position 18 and picking up the second card with the A side thereof facing in a direction, such as upward, for printing. At 80b, printing on the A side of the first card is finished and the card transport 16a transports the first card to the card flipper which is configured to lift the first card from the card transport 16a, flip the first card so that the B side thereof (indicated by 1A/1B) is now facing in the correct direction for printing, and ultimately place the first card back onto the card transport 16a. Also in 80b, the card transport 16b transports the second card into the card printing mechanism for printing on the A side of the second card. At 80c, the card transport 16a transports the now flipped first card back to the card printing mechanism for printing on the B side (indicated by 1B in FIG. 7) thereof. Also, the card transport 16b transports the second card to the card flipper which is configured to lift the second card from the card transport 16b, flip the second card so that the B side thereof (indicated by 2A/2B) is now facing in the correct direction for printing, and ultimately place the second card back onto the card transport 16b. At 80d, printing on the B side of the first card is finished and the card transport 16a transports the first card to the card flipper and ultimately to the common card discharge position to discharge the first card from the system 10. The card transport 16a can thereafter return to the common card pick-up position to pick up a new first card. Also in 80d, the card transport 16b transports the second card back into the card printing mechanism for printing on the B side of the second card. Once printing on the B side of the second card is completed, the card transport 16b transports the second card to the card flipper and ultimately to the common card discharge position to discharge the second card from the system 10. The card transport 16b can thereafter return to the common card pick-up position to pick up a new second card, with the card transport 16a having transported the new first card into the card printing mechanism to repeat 80a.

In general, the printing sequence 80 in FIG. 7 can be described as: printing on the A side of the first card, followed by printing on the A side of the second card, followed by printing on the B side of the first card, followed by printing on the B side of the second card. This printing sequence may be referred to as an AABB printing sequence. However, other printing sequences are possible including printing on the A side of the first card, followed by printing on the B side of the first card, followed by printing on the A side of the second card, followed by printing on the B side of the second card (an ABAB printing sequence); or printing on the A side of the first card, followed by printing on the B side of the second card, followed by printing on the B side of the first card, followed by printing on the A side of the second card (an ABBA printing sequence); or printing on the A side of the first card, followed by printing on the B side of the second card, followed by printing on the A side of the second card, followed by printing on the B side of the first card (also an ABAB printing sequence); or printing on the B side of the first card, followed by printing on the B side of the second card, followed by printing on the A side of the first card, followed by printing on the A side of the second card (a BBAA printing sequence); and many other printing sequences.

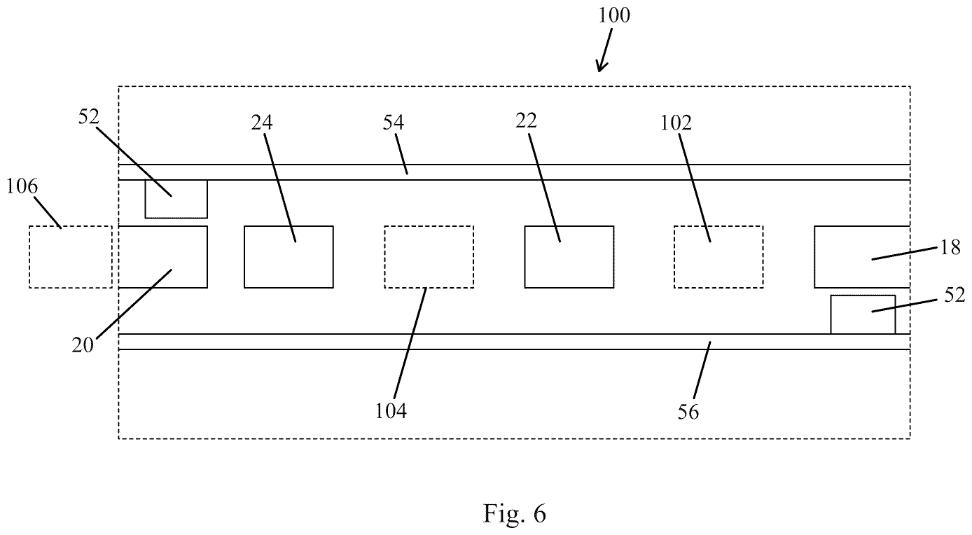

FIG. 6 is a schematic depiction of another embodiment of a duplex printing system 100. Elements in the system 100 that are the same as or similar to elements in the system 10 in FIGS. 1 and 3-5 are referenced using the same reference numerals. The system 100 includes the first and second card transports with the platens 52 and the rails 54, 56. The system 100 also includes the common card pick-up position 18, the common card discharge position 20, the card printing mechanism 22 and the card flipper 24. In this embodiment, the card printing mechanism 22 may be configured for DOD printing with one or more radiation curable inks in which case the system 100 may optionally include a pre-treatment station 102 and a radiation curing station 104. The pre-treatment station 102 is configured to treat at least a portion of the surface of the card with plasma to enhance the adhesion of the resulting printing to the card surface. A pre-treatment station that can be utilized is described in U.S. Pat. No. 10,576,769, the entire contents of which are incorporated herein by reference. The radiation curing station 104 is configured to apply radiation to the card surface to cure radiation curable ink or other radiation curable material applied to the card surface. A radiation curing station that can be utilized is described in U.S. 2021/0086530, the entire contents of which are incorporated herein by reference, or available from Entrust Corporation of Shakopee, Minnesota.

In an embodiment, the system 100 in FIG. 6 may include an optional card flipper 106 downstream of the common card discharge location 20. The card flipper 106, if provided, may flip the cards exiting the system 100 into a preferred orientation for placing the card into a card output hopper or into a preferred orientation for a downstream processing module. The optional card flipper 106 may be separate from the system 100 or included in and considered part of the system 100.

Referring to FIG. 8 along with FIG. 6 and FIGS. 1 and 3-5, an example of a printing sequence 180 that can be implemented by the duplex printing system 100 is illustrated. Similarly to the description above with respect to the printing sequence 80, the first card held on the card transport 16a is referenced using numeral “1” and the second card held on the card transport 16b is referenced using numeral “2”. In addition, each card is depicted as having an A side and a B side. The A side of the first card and the A side of the second card are the same sides of the two cards, such as the sides intended to have the printed images of the intended cardholders of the two cards, or the sides intended to have the account numbers, or the sides intended to have the names of the intended cardholders of the two cards, etc. Similarly, the B side of the first card and the B side of the second card are the same sides of the two cards, such as the sides having the magnetic strips, or the sides intended to have the CVV codes, or the sides intended to have expiration dates of the cards, or the sides having signature panels for receiving signatures of the intended cardholders of the two cards, etc. There are other ways that the A and B sides of the cards could be characterized. However one characterizes the A and B sides, the A side of the first card is intended to be the same side as the A side of the second card, and the B side of the first card is intended to be the same side as the B side of the second card.

In the printing sequence 180 in FIG. 8, at 180a the card transport 16a has been actuated to the common card pick-up position 18 and has picked-up the first card with the A side thereof facing upward for printing, followed by the card transport 16a transporting the first card into the pre-treatment station 102 for pre-treating the A side (this is indicated as 1A) thereof. Also, the card transport 16b is depicted at the common card pick-up position 18 and picking up the second card with the A side thereof facing upward for printing. At 180b, the A side of the first card has been pre-treated and the card transport 16a transports the first card into the card printing mechanism for printing on the A side. Also, the card transport 16b transports the second card into pre-treatment station 102 for pre-treating the A side (this is indicated as 2A) thereof.

With continued reference to FIG. 8, at 180c′, printing on the A side of the first card is finished and the card transport 16a transports the first card to the curing station 104 to cure the radiation curable material applied by the card printing mechanism. Also, the card transport 16b transports the second card into the card printing mechanism for printing on the A side (indicated by 2A) thereof. Alternatively, 180c″ depicts the first card, after curing, being transported by the card transport 16a into the card flipper while the second card is in the card printing mechanism. The card flipper lifts the first card from the card transport 16a, flips the first card so that the B side thereof (indicated by 1A/1B) is now facing upward for printing thereon, with the first card ultimately placed back onto the card transport 16a.

With continued reference to FIG. 8, at 180d, the first card is depicted as being transported by the card transport 16a back to the pre-treatment station to pre-treat the B side of the first card, followed by the first card being transported by the card transport 16a back into the card printing mechanism for printing on the B side thereof. Also, 180d depicts the second card transported by the card transport 16b to the curing station to cure the radiation curable material applied to the A side of the second card, followed by the second card being transported by the card transport 16b to the card flipper which lifts the second card from the card transport 16b, flips the second card so that the B side thereof (indicated by 2A/2B) is now facing upward for printing thereon, with the second card ultimately placed back onto the card transport 16b.

With continued reference to FIG. 8, at 180e, printing on the B side of the first card is finished and the first card transported by the card transport 16a to the curing station to cure the radiation curable material applied to the B side of the first card, followed by the first card being transported by the card transport 16b back to the card flipper which may or may not flip the first card, with the first card ultimately being discharged from the system. The card transport 16a can thereafter return to the common card pick-up position to pick up a new first card. Also, 180e depicts the second card being transported by the card transport 16b back to the pre-treatment station to pre-treat the B side of the second card, followed by the second card being transported by the card transport 16b back into the card printing mechanism for printing on the B side thereof. Once printing on the B side of the second card is completed, the card transport 16b transports the second card to the curing station to cure the radiation curable applied to the B side thereof, and then transported to the card flipper, which may or may not flip the second card, and ultimately to the common card discharge position to discharge the second card from the system 100. The card transport 16b can thereafter return to the common card pick-up position to pick up a new second card, with the card transport 16a having transported the new first card into the pre-treatment mechanism (or into the card printing mechanism) to repeat 180a.

The duplex printing systems described herein may be standalone systems that operate by themselves to print on cards. Alternatively, the duplex printing systems described herein may be incorporated into a larger card personalization system. For example, FIG. 9 depicts an example of a card personalization system 200 that includes either one of the duplex printing systems 10, 100. The card personalization system 200 further includes a card input 202 and a card output 204 with the duplex printing system 10, 100 between the card input 202 and the card output 204, one or more optional card processing systems 206 between the duplex printing system 10, 100 and the card input 202, and one or more optional card processing systems 208 between the duplex printing system 10, 100 and the card output 204.

The card input 202 can be configured to hold a plurality of cards waiting to be personalized and that mechanically feeds the cards one by one into the system 200 using a suitable card feeder. In this configuration, the card input 202 is often termed a card input hopper. The construction and operation of card inputs and card input hoppers is well known in the art. The card input 202 can be configured with a multihopper configuration where the card input 202 is configured to simultaneously hold different card stock (for example, Visa® and Mastercard® branded card stock; driver's license card stock from different states; identification card stock having different security levels; etc.) waiting to be processed. Each type of card stock can be selectively input into the system 200 as selected by a controller 210 based on the type of card to be personalized. In another embodiment, the card input 202 can be configured as an input slot that permits cards to be fed, for example manually, one-by-one into the system 200.

The card output 204 can be configured to hold a plurality of cards after they have been personalized in the system 200. In this configuration, the card output 204 is often termed a card output hopper. The construction and operation of card output hoppers is well known in the art. Like the card input 202, the card output 204 can also be configured with a multihopper configuration where the card output 204 is configured to simultaneously hold different card stock (for example, Visa® and Mastercard® branded card stock; driver's license card stock from different states; identification card stock having different security levels; etc.) after they have been personalized. Each type of card stock can be selectively output from the system 200 as selected by the controller 210 based on the type of card that has been personalized. In another embodiment, the card output 204 can be configured as an output slot from which the personalized cards are discharged one by one from the system 200.

The optional card processing system(s) 206 and the optional card processing system(s) 208 can be one or more stations that are configured to perform any type of additional card personalization/processing (i.e. in addition to the printing by the duplex printing system 10, 100) controlled by the controller 210. Examples of the additional card processing systems 206, 208 include, but are not limited to, an integrated circuit chip programming station that is configured to program the chip on each card, a magnetic strip encoder for encoding data on the magnetic strip of each card, an embossing station having an embosser configured to emboss characters on the cards, an indent station having an indenter configured to indent one or more characters on the cards, a laser marking station with a laser configured to perform laser marking on the cards, a lamination station with a laminator configured to apply one or more laminates to the cards, a topcoat station with a topcoat applicator configured to apply a topcoat to one or more of the surfaces of the cards, a security station with a security feature applicator configured to apply a security feature to one or more of the surfaces of the cards, a quality assurance system that checks the quality of card processing, and other processing.

In an embodiment, the card printing systems 10, 100 can be controlled by the system controllers 26, 210 to switch between a duplex printing mode for printing on cards that require both sides to be printed on, and a simplex printing mode for printing on cards that require only a single side of the cards to be printed on. The printing systems 10, 100 may be switched back and forth between the duplex printing mode and the simplex printing mode by the system controllers depending upon whether the cards require two-sided printing or single sided printing. The term card printing system may refer to the system 10, 100 operating in either the duplex printing mode or the simplex printing mode. Because the card transport mechanism described herein is configured so that the cards do not need to be transferred from one of the movable card transports to the other, the described card printing system can operate faster in the simplex printing mode compared to a card printing system that needs to transfer cards from one card transport mechanism in the card printer to a second card transport mechanism in the card printer.

FIG. 10 depicts an example of one specific possible configuration of the card personalization system 200. Elements that are the same or similar to elements in FIG. 9 are referenced using the same reference numerals. In this example, the system is depicted as including an integrated circuit chip programming station 212, an optional magnetic strip encoder 214, an optional a laser marking system 216, and an optional quality assurance system 218.

The integrated circuit chip programming station 212 may include a single integrated circuit programming mechanism so that a single chip on a single card is programmed in the integrated circuit chip programming station 212 at any moment in time (or the single card can be passed-through without programming). However, in an embodiment, the integrated circuit chip programming station 212 may include a plurality of integrated circuit chip programming mechanisms, where each one of the integrated circuit chip programming mechanisms is configured to program the integrated circuit chip on a respective one of the cards received thereby so that multiple chips on multiple cards can be simultaneously programmed in the integrated circuit chip programming station 212 at any moment in time. One or more of the integrated circuit chip programming mechanisms may be controlled to allow a card to pass-through without programming of the integrated circuit chip. Alternatively, the integrated circuit chip programming station 212 may include a pass-through location that may be devoid of an integrated circuit chip programming mechanism to allow a card to pass-through without programming of the integrated circuit chip.

The magnetic strip encoder 214, if present, is configured to magnetically encode data on the magnetic strip of each card. The laser marking system 216, if present, includes one or more lasers that are configured to perform laser marking on the cards. The quality assurance system 218, if present, can include a vision system for checking the quality of printing or laser marking applied to the cards.

The card personalization system 200 may be configured as a large volume batch production card personalization system (or central issuance personalization systems), or configured as a desktop card personalization system. Large volume batch production card processing system (or central issuance processing system) process cards in high volumes, for example on the order of high hundreds or thousands per hour, and employ multiple processing stations or modules to process multiple cards at the same time to reduce the overall per card processing time. Examples of central issuance card personalization systems include the MX family of central issuance systems available from Entrust Corporation of Shakopee, Minnesota. Other examples of central issuance systems are disclosed in U.S. Pat. Nos. 4,825,054, 5,266,781, 6,783,067, and 6,902,107, all of which are incorporated herein by reference in their entirety. Desktop card personalization systems are typically designed for relatively small scale, individual card processing. In desktop personalization systems, a single card to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Corporation of Shakopee, Minnesota. Other examples of desktop card personalization systems are disclosed in U.S. Pat. Nos. 7,434,728 and 7,398,972, each of which is incorporated herein by reference in its entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A duplex printing system usable in a card personalization system, comprising:
a common card pick-up position;
a common card discharge position;
a card printing mechanism between the common card pick-up position and the common card discharge position, the card printing mechanism is configured to perform printing on cards that are input into the duplex printing system;
a card flipper between the common card pick-up position and the common card discharge position, the card flipper is configured to flip a card;
a card transport mechanism that transports cards within the duplex printing system including to and from the card printing mechanism and the card flipper, the card transport mechanism includes first and second separately movable card transports each of which is configured to support a respective card thereon; and
the first and second separately movable card transports are each separately actuatable to occupy the common card pick-up position and occupy the common card discharge position, and the first and second separately movable card transports are each separately actuatable to move between the common card pick-up position and the common card discharge position and transport the cards to and from the card printing mechanism and the card flipper.

2. The duplex printing system of claim 1, wherein the card printing mechanism includes at least one drop-on-demand print head.

3. The duplex printing system of claim 2, wherein the card printing mechanism further includes a surface treatment station and a radiation curing station.

4. The duplex printing system of claim 1, wherein the card transport mechanism includes first and second transport rails on which the first and second separately movable card transports are respectively supported, and the first and second transport rails extend from the common card pick-up position, to the card printing mechanism, to the card flipper, and to the common card discharge position.

5. The duplex printing system of claim 1, further comprising a system controller that is configured to control the duplex printing system to simultaneously have a first card and a second card therein, with the first card on the first movable card transport and the second card on the second movable card transport;
wherein each of the first card and the second card has an A side and a B side, and the system controller controls the duplex printing system to implement the following printing sequence: printing on the A side of the first card, followed by printing on the A side of the second card, followed by printing on the B side of the first card, followed by printing on the B side of the second card.

6. A card personalization system that includes the duplex printing system of claim 1.

7. The card personalization system of claim 6, further comprising a card input and a card output, and the duplex printing system is disposed between the card input and the card output.

8. The card personalization system of claim 7, further comprising an integrated circuit chip programming station located between the duplex printing system and the card input.

9. A duplex printing system usable in a card personalization system, comprising:
a card infeed;
a card discharge;
a card printing mechanism between the card infeed and the card discharge, the card printing mechanism is configured to perform printing on cards that are input into the duplex printing system;
a card flipper between the card infeed and the card discharge, the card flipper is configured to flip a card;
a card transport mechanism that transports cards within the duplex printing system, the card transport mechanism includes first and second separately movable card transports each of which is configured to support a respective card thereon; and
a system controller that is configured to control the duplex printing system to simultaneously have a first card and a second card therein, with the first card on the first movable card transport and the second card on the second movable card transport;
wherein each of the first card and the second card has an A side and a B side, and the system controller controls the duplex printing system to implement the following printing sequence: printing on the A side of the first card, followed by printing on the A side of the second card, followed by printing on the B side of the first card, followed by printing on the B side of the second card.

10. The duplex printing system of claim 9, wherein the card printing mechanism includes at least one drop-on-demand print head.

11. The duplex printing system of claim 10, wherein the card printing mechanism further includes a surface treatment station and a radiation curing station.

12. The duplex printing system of claim 9, wherein the card transport mechanism includes first and second transport rails on which the first and second separately movable card transports are respectively supported, and the first and second transport rails extend from the card infeed, to the card printing mechanism, to the card flipper, and to the card discharge.

13. A card personalization system that includes the duplex printing system of claim 9.

14. The card personalization system of claim 13, further comprising a card input and a card output, and the duplex printing system is disposed between the card input and the card output.

15. The card personalization system of claim 14, further comprising an integrated circuit chip programming station located between the duplex printing system and the card input.
